(19) United States
(12) Patent Application Publication
(10) Pub. No.: US 2012/0066972 A1
(43) Pub. Date: Mar. 22, 2012

(54) Vertical Planting Apparatus

(76) Inventor: Paul Lin, Taichung City (TW)

(21) Appl. No.: 13/017,165

(22) Filed: Jan. 31, 2011

(30) Foreign Application Priority Data
Sep. 17, 2010 (TW) 099218036

(51) Int. Cl. A01G 9/02

(52) U.S. Cl. 47/82

(57) ABSTRACT

A vertical planting apparatus includes a water storage tank, an n-shaped vertical frame extended upwardly from a side of the water storage tank, a water pump motor installed at the water storage tank for pumping irrigation water stored in the water storage tank out from the top of the n-shaped vertical frame through a water delivery pipe, a water permeating layer hanged within a range surrounded by the n-shaped vertical frame, and a plurality of bags formed on the water permeating layer and provided for growing plants, and the irrigation water outputted from the water delivery pipe enters into the permeating layer through the top of the n-shaped vertical frame and permeates sequentially from top to bottom into each of the bags.

### BACKGROUND OF THE INVENTION

1. Field of the Invention

The present invention generally relates to equipments for growing plants, and more particularly to a vertical planting apparatus.

2. Description of the Related Art

In general, a ring and a hanging hook are used for achieving the effect of hanging conventional hanging potted plants on a wall or a frame. As we all know, the supply of water is an essential factor of growing plants, and it is necessary to water the plants almost everyday. However, it is inconvenient and troublesome for users to water a hanging potted plant, since the plant is hanged at a hard-to-reach height.

With reference to FIG. 5 for an improvement of a conventional hanging basket plant system, the improved hanging basket plant system comprises a pot 41, a water storage tank 42, a water permeable bag 43 mounted onto the pot 41, and a hanging ring 44 installed around the top of the bag 43 and provided for users to hang a hanging potted plant. Although the water storage tank 42 can be used for reducing the frequency of watering this type of hanging-basket potted plants, yet users have to refill irrigation water, when the irrigation water stored in the water storage tank 42 is exhausted. Obviously, the drawback of the inconvenient and troublesome refill of irrigation water at a hard-to-reach height still exists. If too much irrigation water is refilled, the irrigation water will drip all over the floor and cause a messy environment.

With reference to FIG. 6 for a conventional irrigation-free vertical garden system, the system comprises a support frame 51, a plurality of cans 52 mounted slantingly on the support frame 51, an appropriate amount of cultivated soil filled into each can 52, a connecting tube 53 for connecting each can 52 and passing irrigation water sequentially from top to bottom into the cans 52 through each connecting tube 53. However, the irrigation-free vertical garden system does not have the automatic irrigation effect, and the volume of the system becomes very large and occupies much space after the system is assembled. Furthermore, such vertical garden system comes with a slow speed of permeating water from one can 52 to the other, and the plants cultivated at a lower section of the vertical garden may be withered easily due to insufficient water.

### SUMMARY OF THE INVENTION

Therefore, it is a primary objective of the invention to provide a vertical planting apparatus to overcome the shortcoming of having a difficulty of watering plants at a hard-to-reach height.

A secondary objective of the present invention is to provide a vertical planting apparatus that can recycle excessive water to achieve the effect of saving water and overcome the shortcoming of the dripping water that causes a messy environment.

A third objective of the present invention is to provide a vertical planting apparatus with a function of watering plants at a fixed time, and maintaining a normal water supply for the growth of the plants without requiring users to personally water the plants daily.

A fourth objective of the present invention is to provide a vertical planting apparatus with the easy-to-transport and hard-to-topple advantages.

To achieve the foregoing objectives, the present invention provides a vertical planting apparatus, comprising:

a water storage tank, for storing irrigation water, and having an n-shaped vertical frame extended from a side of the water storage tank, a water pump motor installed at the water storage tank, and provided for pumping irrigation water from the water storage tank through a water delivery pipe out of the top of the n-shaped vertical frame; and

a water permeating layer, hanged onto an area enclosed by the n-shaped vertical frame, and having a plurality of bags formed on the water permeating layer for planting a plant, delivering the irrigation water outputted by the water delivery pipe into the water permeating layer through the top of the n-shaped vertical frame, and permeating the irrigation water sequentially from top to bottom into each bag.

In the present invention, an opening is formed at the top of the water storage tank and interconnected to the interior of the water storage tank, and the water permeating layer is disposed at a position above the opening of the water storage tank.

In the present invention, the water permeating layer can be made of a woven cloth material or an unwoven cloth material and has a plurality of tiny through holes.

In the present invention, a roller is installed at each of four corners of the bottom of the water storage tank, and a support leg frame disposed at the central position of the bottom of the water storage tank and extended from the bottom of the water storage tank.

In the present invention, the water pump motor is connected to a timer and controlled by the timer to determine the timing for turning on the water pump motor.

### BRIEF DESCRIPTION OF THE DRAWINGS

FIG. 1 is a perspective view of the present invention;

FIG. 2 is a structural schematic view of the present invention;

FIG. 3 is a schematic view of a status of using the present invention;

FIG. 4 is a schematic view of a bag planted with a plant of the present invention;

FIG. 5 is a structural schematic view of a conventional hanging-basket potted plant; and

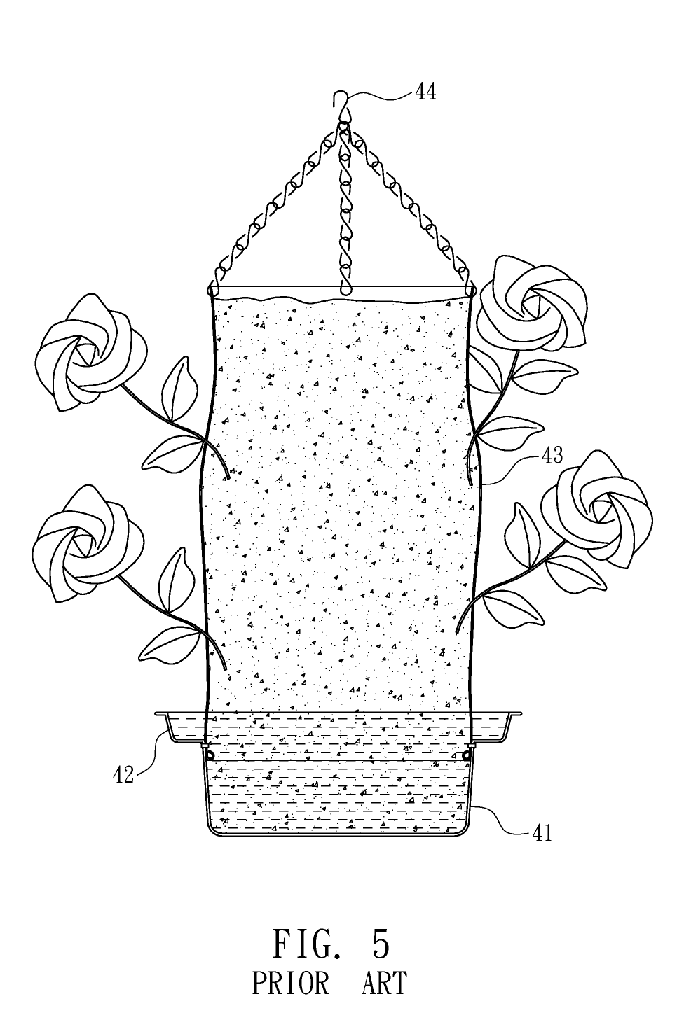

FIG. 6 is a structural schematic view of a conventional irrigation-free vertical garden system.

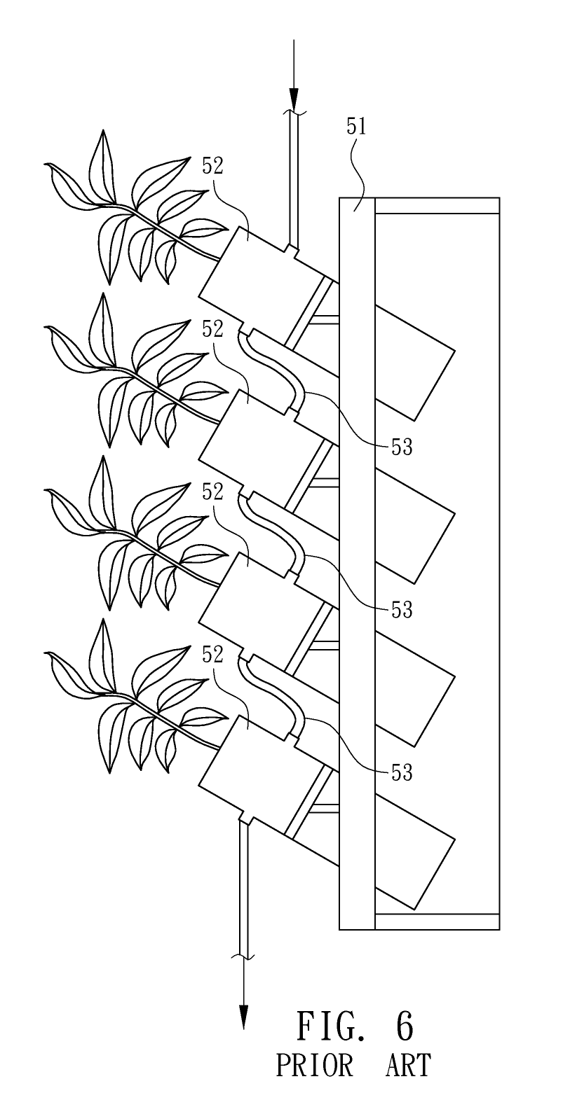

### DETAILED DESCRIPTION OF THE PREFERRED EMBODIMENTS

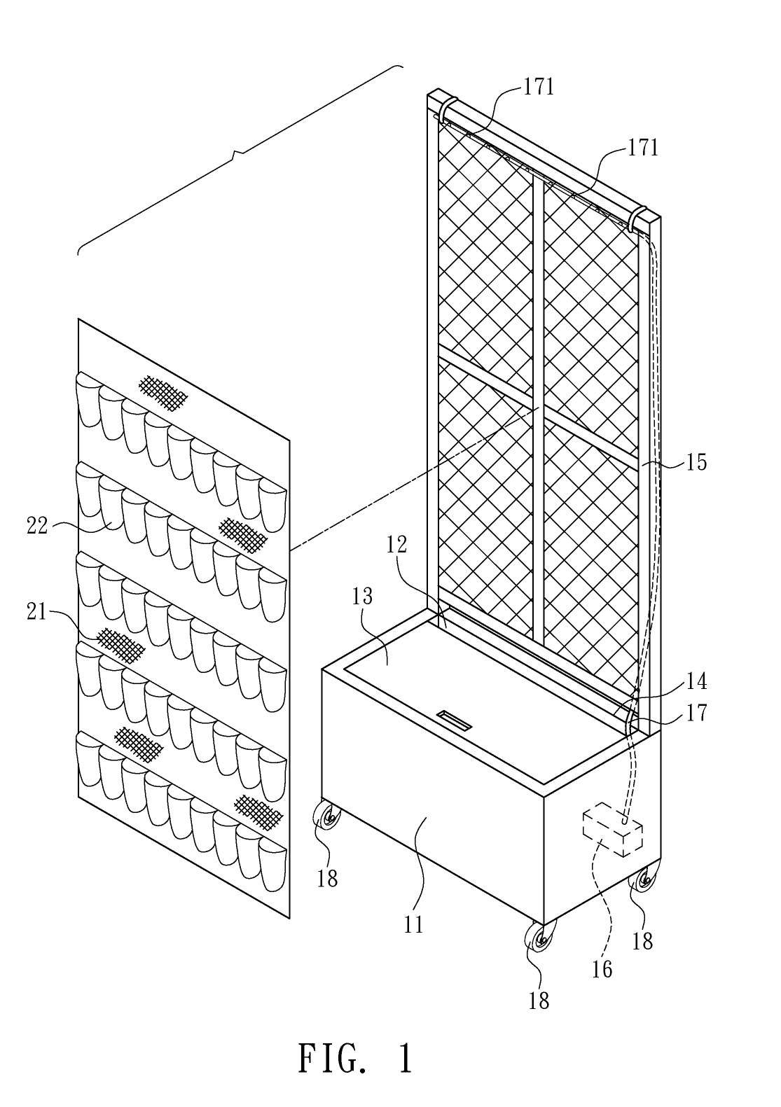

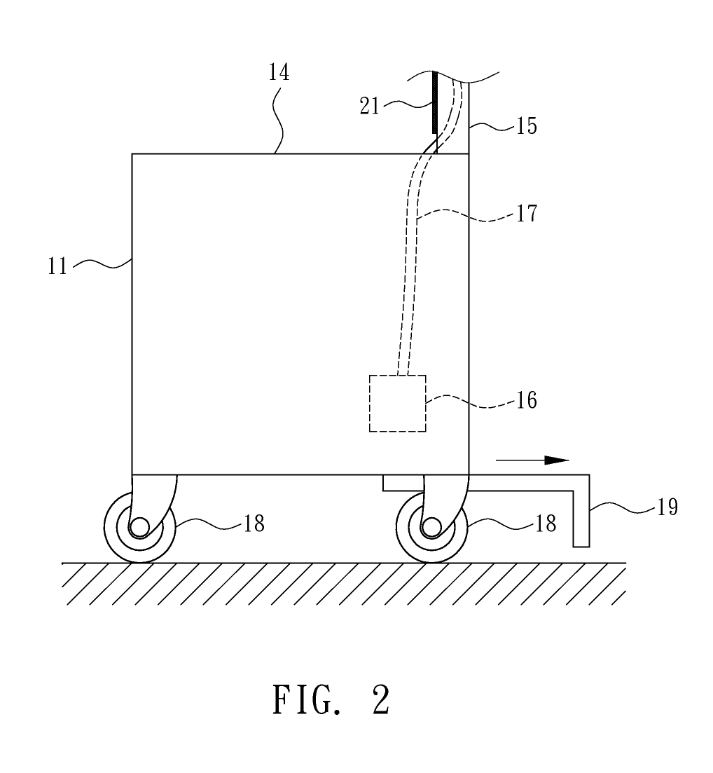

With reference to FIGS. 1 to 3 for a vertical planting apparatus of the present invention, the vertical planting apparatus comprises a water storage tank 11 and a water permeating layer 21.

The water storage tank 11 includes a containing chamber 12 for storing irrigation water, a lifting cover 13 installed at the top of the containing chamber 12 and formed by using a slide structure, an opening 14 formed at a position adjacent to the lifting cover 13 at the top of the containing chamber 11 and interconnected to the containing chamber 12, an n-shaped vertical frame 15 extended upwardly from a side of the water storage tank 11, a water pump motor 16 installed in the containing chamber 12 of the water storage tank 11, a water delivery pipe 17 with an end connected to the water pump motor 16 and another end connected to the top of the n-shaped vertical frame 15, a plurality of downwardly aligned penetrating holes 171 formed on a tube body at the top of the n-shaped vertical frame 15 connected to the water delivery pipe 17 for allowing the water pump motor 16 to pump the irrigation water out from the water storage tank 11 through the water delivery pipe 17 and outputting the water downwardly from the top of the n-shaped vertical frame 15, a roller 18 installed at each of four corners of the bottom of the water storage tank 11, and a support leg frame 19 disposed at a middle position of the bottom of the water storage tank 11 and selectively extended from the bottom of the water storage tank 11.

The water permeating layer 21 is hanged within an area enclosed by the n-shaped vertical frame 15 and disposed at a position above the opening 14 of the water storage tank 11, and the water permeating layer 21 includes a plurality of bags 22 thereon for growing plants, and the water permeating layer 21 can be made of a woven cloth material or an unwoven cloth material and has a plurality of downwardly aligned penetrating holes, such that the irrigation water outputted from the water delivery pipe 17 can be entered into the water permeating layer 21 through the top of the n-shaped vertical frame 15 and then permeated sequentially from top to bottom and finally dispersed uniformly into each bag 22. Since the opening 14 at the top of the water storage tank 11 is disposed at a position below the water permeating layer 21, therefore if there is excessive irrigation water permeated from the bottom of the water permeating layer 21, then the water can be dripped into the containing chamber 12 of the water storage tank 11 through the opening 14 to recycle the excessive irrigation water to achieve the effect of saving water and avoid the drawback of having a messy environment caused by the dripping of water.

In this preferred embodiment of the present invention, the water permeating layer 21 is made of an unwoven cloth material with a thickness from 1.8 mm to 3.8 mm, and a density from 88 kg/m³ to 172 kg/m³, and actual tests show that the unwoven cloth material of the water permeating layer 21 with a thickness of 1.8 mm and a weight per cubic meter from 160 g to 280 g, or a thickness of 3.0 mm and a weight per cubic meter from 280 g to 500 g, or a thickness of 3.0 mm and a weight per cubic meter from 280 g to 500 g can be used for making the water permeating layer 21, and the water permeating layer 21 is preferably made of the unwoven cloth material. Since the inventor of the present invention discovers from actual tests and experiments that if an unwoven cloth with a thickness less than 1.8 mm is used for making the water permeating layer 21, the structural strength of the water permeating layer 21 will be too weak, and the capacity for storing water will not be enough for the water supply required by plants daily. As a result, the frequency of turning on the water pump motor 16 is too high, and thus causing an unnecessary wastes of energy sources. If an unwoven cloth with a thickness greater than 3.8 mm is used for making the water permeating layer 21, the material cost will be increased, and the weight of the unwoven cloth will be increased by 10 to 20 times due to the water content of the water permeating layer 21, and thus resulting in a large increase of load and affecting the overall force bearing capability of the whole support structure.

The unwoven cloth material used for making the water permeating layer 21 can serve as a medium for growing plants, and the unwoven cloth material also can be used for siphon drainage to achieve an automatic irrigation effect. Even if there is a small amount of water at the top, the water can be permeated into the water permeating layer 21 quickly to avoid plants from dried up.

In addition, the water pump motor 16 of the present invention can be connected to a timer (not shown in the figure), such that the water pump motor 16 is controlled by the timer to determine the timing of turning on the water pump motor 16. The present invention has the function of watering the plants at a fixed time without requiring users to water the plants daily, as well as the function of maintaining a normal water supply required for the growth of the plants.

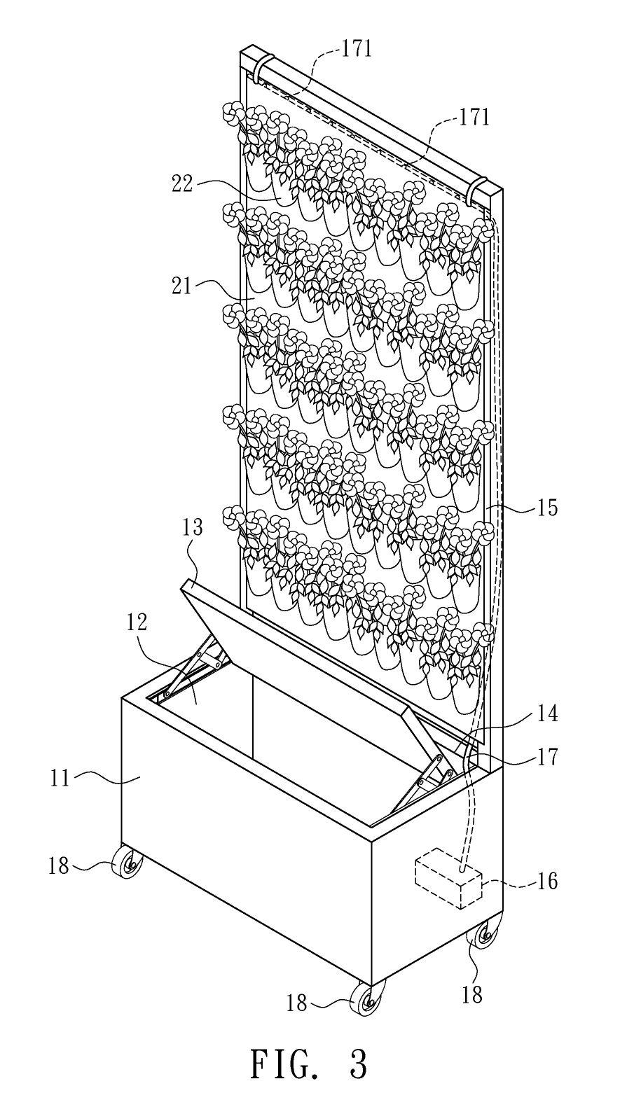

In a practical use of the present invention comprised of the aforementioned elements as shown in FIG. 3, the present invention adopts the water pump motor 16 and the water delivery pipe 17 to send irrigation water to the top of the water permeating layer 21, and allow the irrigation water to permeate sequentially from top to bottom into each bag 22 of the water permeating layer 21 to achieve the effect of watering the plants, so as to overcome the difficulty of watering a plant at a hard-to-reach height. Since the present invention relates to a vertical garden, the area of growing plants can be increased effectively, and the utility of the space can be maximized effectively. In addition, the design of the roller 18 and the support leg frame 19 at the bottom of the water storage tank 11 gives the easy-to-move and hard-to-topple advantages.

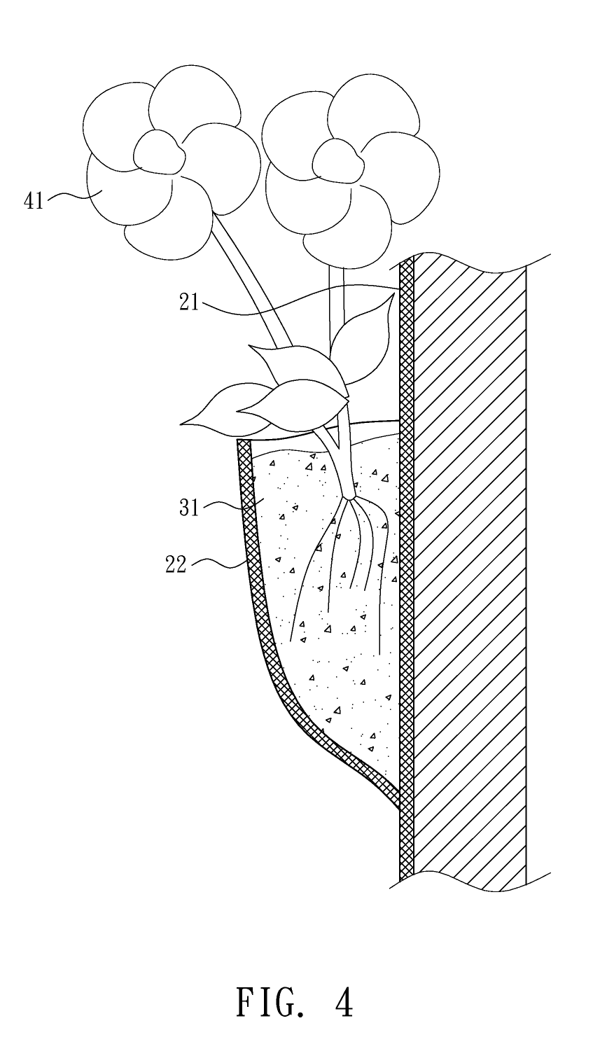

In addition, a conventional potted plant is usually watered with a non-uniform moisture due to the too-high viscosity of the soil medium, but the present invention adopts the bags 22 of the water permeating layer 21 to wrap the soil medium for growing the plants 41 (as shown in FIG. 4), such that the moisture can be permeated uniformly and effectively from the bag 22 into the soil medium, and the moisture of the soil will be uniform after the watering process takes place, and thus the present invention can improve the applicability of the medium for growing plants.

What is claimed is:

1. A vertical planting apparatus, comprising:
a water storage tank, for storing irrigation water, and having an n-shaped vertical frame extended from a side of the water storage tank, and a water pump motor installed at the water storage tank and provided for pumping irrigation water from the water storage tank through a water delivery pipe out of the top of the n-shaped vertical frame; and
a water permeating layer, hanged onto an area enclosed by the n-shaped vertical frame, and having a plurality of bags formed on the water permeating layer for planting a plant, delivering the irrigation water outputted from the water delivery pipe into the water permeating layer through the top of the n-shaped vertical frame, and permeating the irrigation water sequentially from top to bottom into each bag.

2. The vertical planting apparatus of claim 1, wherein the water storage tank has an opening formed at the top of the water storage tank and interconnected to the interior of the water storage tank, and the water permeating layer is disposed above the opening of the water storage tank.

3. The vertical planting apparatus of claim 2, further comprising a lifting cover installed at a position adjacent to the opening at the top of the water storage tank.

4. The vertical planting apparatus of claim 1, wherein an end of the water delivery pipe is connected to the water pump motor, and another end of the water delivery pipe is connected to the top of the n-shaped vertical frame, and the water delivery pipe is connected to a plurality of downwardly aligned penetrating holes formed on the tube body at the top of the n-shaped vertical frame.

5. The vertical planting apparatus of claim 1, wherein the water permeating layer is made of an unwoven cloth material with a thickness from 1.8 mm to 3.8 mm, and the water permeating layer includes a plurality of downwardly aligned penetrating holes formed thereon.

6. The vertical planting apparatus of claim 1, wherein the water permeating layer is made of an unwoven cloth material with a density from 88 kg/m³ to 172 kg/m³, and the water permeating layer includes a plurality of downwardly aligned penetrating holes formed thereon.

7. The vertical planting apparatus of claim 1, wherein the water permeating layer is made of an unwoven cloth material with a thickness of 1.8 mm and a weight per cubic meter from 160 g to 280 g, and the water permeating layer includes a plurality of downwardly aligned penetrating holes formed thereon.

8. The vertical planting apparatus of claim 1, wherein the water permeating layer is made of an unwoven cloth material with a thickness of 3.0 mm and a weight per cubic meter from 280 g to 500 g, and the water permeating layer includes a plurality of downwardly aligned penetrating holes formed thereon.

9. The vertical planting apparatus of claim 1, wherein the water permeating layer is made of an unwoven cloth material with a thickness of 3.6 mm and a weight per cubic meter from 350 g to 620 g, and the water permeating layer includes a plurality of downwardly aligned penetrating holes formed thereon.

10. The vertical planting apparatus of claim 1, wherein the water storage tank further includes a roller installed at each of four corners of the bottom of the water storage tank.

11. The vertical planting apparatus of claim 10, wherein the water storage tank further includes a support leg frame installed at a middle position of the bottom of the water storage tank and selectively extended out from the bottom of the water storage tank.

12. The vertical planting apparatus of claim 1, wherein the water pump motor is connected to a timer controlled by the timer for determining the timing of turning on the water pump motor.
